(19) United States
(12) Patent Application Publication
(10) Pub. No.: US 2008/0060508 A1
(43) Pub. Date: Mar. 13, 2008

(54) LIGHTWEIGHT ARMOR COMPOSITE, METHOD OF MAKING SAME, AND ARTICLES CONTAINING THE SAME

(76) Inventor: JAMIN MICARELLI, Issaquah, WA (US)

Correspondence Address: AKERMAN SENTERFITT, P.O. BOX 3188, WEST PALM BEACH, FL, 33402-3188, US

(21) Appl. No.: 11/852,824

(22) Filed: Sep. 10, 2007

Related U.S. Application Data
(60) Provisional application No. 60/825,342, filed on Sep. 12, 2006.
(60) Provisional application No. 60/869,606, filed on Dec. 12, 2006.

(51) Int. Cl. F41H 5/06; B32B 15/00

(52) U.S. Cl. 89/36.02; 428/403; 428/406

(57) ABSTRACT

An armor composite can have a continuous phase comprising a first metal and a plurality of discrete abrasive particles with each having a coating thereon. The plurality of discrete abrasive particles can be suspended in the continuous phase comprising the first metal. A first bond strength between the plurality of discrete abrasive particles with the coating and the continuous phase comprising the first metal can be higher as compared to a second bond strength between the plurality of discrete abrasive particles without the coating and the continuous phase comprising the first metal.

### CROSS-REFERENCE TO RELATED APPLICATIONS

This application claims priority to Provisional Application No. 60/825,342 entitled “LIGHTWEIGHT METAL-ABRASIVE PARTICLE COMPOSITE, METHOD OF MAKING THE SAME, AND ARTICLES CONTAINING THE SAME” filed on Sep. 12, 2006, and Provisional Application No. 60/869,606 entitled “LIGHTWEIGHT ARMOR COMPOSITE, METHOD OF MAKING THE SAME, AND ARTICLES CONTAINING THE SAME” filed on Dec. 12, 2006, both of which are incorporated by reference in their entirety into the present application.

### FIELD OF THE INVENTION

The invention relates to light weight armor composites that include highly compression-resistant abrasive particles and a continuous metal phase, methods of making the same and articles containing the same.

### BACKGROUND OF THE INVENTION

In any armor application, several factors can be critical. These factors include the functionality of the armor, integrity of the armor and weight of the armor.

A first factor is the functionality of the armor. One aspect of functionality deals with the ability of the armor to stop a first projectile. Another aspect deals with the ability to stop subsequent projectiles. Since in many circumstances stopping a single projectile is not enough to provide the desired protection, multi-hit performance may be of critical importance.

Another factor connected to functionality is the integrity of the armor. Conventional, metal-sintered ceramic armor plates are fragile and the underlying sintered ceramic network is brittle and may break when the plate is dropped or exposed to a jarring shock, for instance, when an armored vehicle hits something. Thus, there is a significant danger that metal-sintered ceramic armor plates may become ineffective for stopping munitions.

Another factor is the weight of the plate required for the desired functionality. Lighter armor is preferable in nearly all armor applications and lightweight armor is critical for certain applications including, but not limited to, armor for personal protection, armored vehicles, aircrafts and temporary shelters.

### SUMMARY OF THE INVENTION

In one exemplary embodiment of the present disclosure, an armor composite can have a continuous first metal, and a plurality of discrete abrasive particles with each having a coating thereon. The plurality of discrete abrasive particles can be suspended in the continuous phase including a first metal. A first bond strength between the plurality of discrete abrasive particles with the coating and the continuous phase can be higher as compared to a second bond strength between the plurality of discrete abrasive particles without the coating and the continuous phase.

In another exemplary embodiment of the present disclosure, an armor composite can have a continuous phase comprising a first metal, and a plurality of discrete abrasive particles. The plurality of discrete abrasive particles can be suspended in the continuous phase and an average size of each the plurality of discrete abrasive particles can be greater than 250 microns.

In another exemplary embodiment of the present disclosure, an armor system can have a substrate, and an armor composite having a continuous phase comprising a first metal and a plurality of discrete abrasive particles. Each of the plurality of discrete abrasive particles can have a coating thereon and can be suspended in the continuous first metal. The coating can have a second metal. The continuous phase can be between 5% and 50% of the weight of the armor composite. A first bond strength between the plurality of discrete abrasive particles with the coating and the continuous phase comprising a first metal can be higher as compared to a second bond strength between the plurality of discrete abrasive particles without the coating and the continuous phase comprising the first metal. The armor composite can be attached to the substrate.

In another exemplary embodiment of the present disclosure, a method can include, but is not limited to, providing a first metal, providing a plurality of discrete abrasive particles, heating the first metal to a maximum temperature less than a sintering temperature of the plurality of discrete abrasive particles, mixing the plurality of discrete abrasive particles with the first metal to form a mixture, cooling the mixture to form an armor composite, and attaching the armor composite to a substrate.

An advantage of one or more of the exemplary embodiments of the present disclosure is that they may not require an underlying in-tact sintered structure to provide ballistic performance. Thus, in one or more exemplary embodiments, the present disclosure can provide an armor that maintains ballistic performance even after impact by a blunt force or a high speed projectile. In addition, because an in-tact sintered structure is not necessary, the one or more exemplary embodiments can provide superior multi-hit ballistic performance when compared to armor plates made from sintered or green ceramic forms infiltrated by a metal phase.

Another advantage of one or more of the exemplary embodiments of the present disclosure is that they can rely on strong deformable bonds between the coating material and the continuous first metal phase to immobilize the coated discrete abrasive particles. Thus, the bonds between the coated discrete abrasive particles can be stronger than the brittle bonds generally formed between sintered ceramic particles. Another advantage of one or more of the exemplary embodiments of the present disclosure is that the bonds formed using the coated discrete abrasive particles can form much more rapidly than the sintered bonds used in conventional armors containing sintered ceramics. Thus, less energy may be necessary to create the bonds necessary for ballistic performance.

### BRIEF DESCRIPTION OF THE DRAWINGS

A fuller understanding of the present invention and the features and benefits thereof will be accomplished upon review of the following detailed description together with the accompanying drawings, in which:

FIG. 1A. shows the morphology of a portion of an armor composite of the present invention. FIG. 1B shows the morphology of a metallic coating on an abrasive particle according to an embodiment of the present invention.

FIG. 2 shows exemplary applications for armor systems of the claimed invention, including (A) basic military helmet, (B) advanced helmet, (C) chest and back plates with SAPI—small arms protective insert, (D) personnel ballistic shield, (E) body armor, (F) armor panels, (G) vehicles, and (H) hardened buildings or parts of buildings.

FIG. 3A. shows the morphology of a portion of an armor composite of the present invention. FIG. 3B. shows the morphology of an abrasive powder coating on an abrasive particle according to an embodiment of the present invention.

FIG. 4 shows the morphology of a portion of an armor composite of the present invention where the discrete abrasive particles are not coated.

### DETAILED DESCRIPTION

One aspect of the present invention is drawn to an armor system that includes an armor composite attached to a substrate. The armor composite may have a continuous phase that includes a first metal. The armor composite may also include a plurality of discrete abrasive particles. The discrete abrasive particles may be coated such that when suspended in a metallic continuous phase, the coated particles exhibit improved bonding to the metallic continuous phase than discrete abrasive particles without the coating. The discrete abrasive particles may be coated by a second metal. The metal coating may be at least a monolayer of the second metal thick. The coated discrete abrasive particles are generally suspended in the first metal phase.

In some embodiments of the present invention, the coating does not include the first metal. In some embodiments, the coating may be second metal that is essentially residue free.

The discrete abrasive particles may be coated with an abrasive powder. The particle size of the abrasive powder may be smaller than that of the abrasive particles. The abrasive particle may have a diameter at least 4 times larger than the abrasive powder, or at least 10 times larger than the abrasive powder, at least 20 times larger than the abrasive powder, or at least 50 times larger than the abrasive powder. Thus, depending on the size of the abrasive particle, abrasive powders useful for coating the abrasive particles disclosed herein may be 192 microns (U.S. 80 mesh) or smaller, or 141 microns (U.S. 100 mesh) or smaller, or 66 microns (U.S. 220 mesh) or smaller, or 44 microns (U.S. 280 mesh) or smaller, or 19.7 microns (U.S. 500 mesh) or smaller, or 12.2 microns (U.S. 800 mesh) or smaller.

As used herein, the term “discrete” has its generally accepted meaning. In particular, as used herein, “discrete abrasive particles” refers to abrasive particles that are not directly bonded to adjacent abrasive particles. For example, abrasive particles that are sintered together are not “discrete” particles as used herein. It is noteworthy that as used herein, a coated abrasive particle is still “discrete” if it is joined to another coated abrasive particle by a second metal containing coating interposed between each. Similarly, an abrasive particle is “discrete” if the abrasive particle is bonded to an abrasive powder, so long as it is not sintered to another abrasive particle.

As used herein, “first metal” refers to a first metal or an alloy including more than 50 wt-% of the first metal. As used herein, “second metal” refers to a second metal or an alloy including more than 50 wt-% of the second metal. As used herein, a “phase” refers to a phase of material that may include one or more metals, a phase may be a pure metal or a may be an alloy.

As use herein, “residue free coating” or “residue free second metal” refers to a coating that contains less than about 1 wt-% abrasive particle residue, whether solid fragments or dissolved abrasive particle constituents. For instance, abrasive particle residue may be formed when an abrasive material is exposed to a temperature exceeding the sintering temperature of the abrasive material, and residue is likely to form when abrasive materials are exposed to temperatures that exceed the temperature of formation of the abrasive particle.

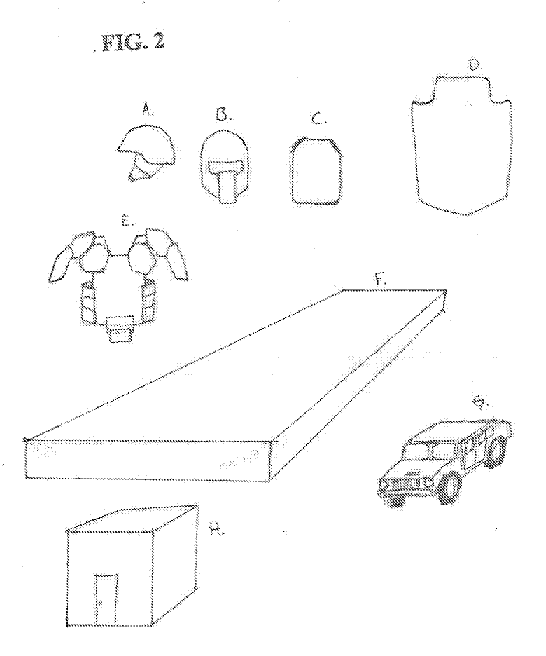

As used herein, the term “attached” refers to both containment and physical attachment, such as bolting, riveting or adhering, or supporting. For example, containment includes, but is not limited to, embodiments where an armor composite is placed inside a pocket in a substrate, such as a garment or temporary shelter. Some of these embodiments are shown in FIG. 2.

The majority of currently available metal-ceramic armor composites rely on a preformed green or sintered ceramic structure made of small ceramic particles. These preforms are generally infiltrated by a continuous metal phase. The nature of these prior art materials is such that damage to the underlying ceramic matrix may render the armor plate unable to stop munitions.

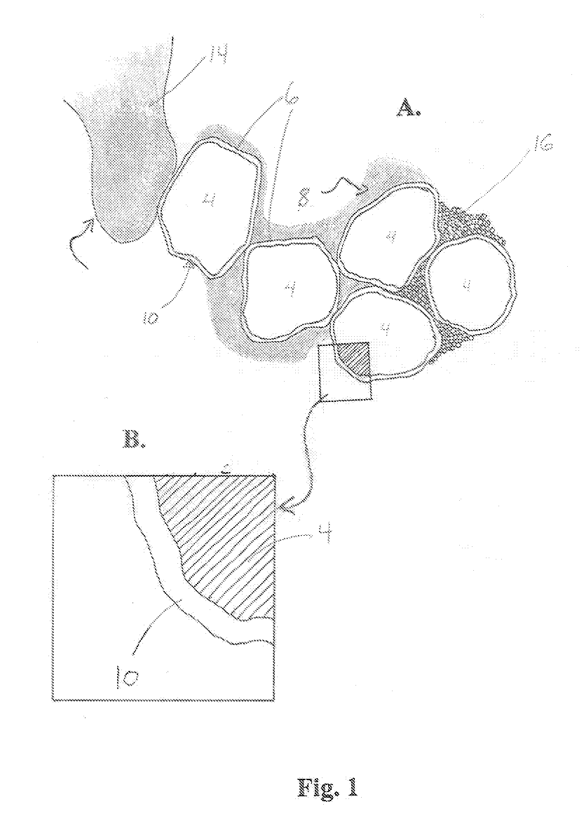

As shown in FIG. 1, one exemplary embodiment of the present disclosure has armor that includes discrete abrasive particles 4 to break apart munitions that impact the composite material. The coated discrete abrasive materials 6 of the present invention may be suspended in a continuous metal containing phase 8. The abrasive particles 4 used can be discrete and may be coated with a second metal comprising material 10 or an abrasive powder (not shown). These discrete abrasive particles 4 can be held in place by strong bonds between the first metal containing phase 8 and the coating 10 or, where a metallic coating is used, between the coatings 10 of adjacent coated discrete abrasive particles 6. There can be generally little or no direct bonding between adjacent abrasive particles 4. In addition, bonding between the discrete abrasive particles 4 may not be possible where the discrete abrasive particles 4 are not exposed to temperatures at or above the sintering point of the abrasive particles 4 during the armor forming process. Surprisingly, even without an underlying sintered ceramic matrix, the armor of exemplary embodiments of the present disclosure shows superior projectile-stopping performance when compared to commercially available armors.

Although the average particle size of the discrete abrasive particles 4 of exemplary embodiments of the present disclosure may be larger, in some embodiments, the abrasive particles 4 may be up to about 2 centimeters. In other embodiments, the average particle size of the discrete abrasive particles 4 may be between about 50 microns and about 2 centimeters or between about 250 microns and about 2 centimeters. The average particle size of the discrete abrasive particles 4 may be between about 500 microns and 2 centimeters. The average particle size of the discrete abrasive particles 4 may be between about 1000 microns and 1 centimeter. The present disclosure envisions all possible ranges and combinations of the average particle sizes disclosed herein. The discrete abrasive particles useful in the inventive armors may be coated or uncoated discrete abrasive particles.

A coating 10 containing the second metal may be coated onto the discrete abrasive particles 4. In one embodiment, a second metal comprising coating 10 may be at least a monolayer thick. The coating 10 may be between about 1250 microns and about 0.1 micron thick. In another embodiment, the coating 10 may be between about 125 microns and about 0.5 microns thick. In still another embodiment, the coating 10 may be between about 25 microns and about 1 micron thick. The coating 10 on the discrete abrasive particles 4 may be continuous, i.e. may encapsulate the entire abrasive particle 4. The use of metal-to-metal bonds creates bonds that are stronger than metal-to-ceramic bonds. Thus, the metal coating 10 provides for improved bonding between the coated discrete abrasive particles 6 and the continuous first metal containing phase 8.

The discrete abrasive particles 4 of exemplary embodiments of the present disclosure can function to destroy the incoming projectile. The abrasive particles 4 that may be useful in exemplary embodiments of the present disclosure can be highly compression resistant and include abrasive particles 4 composed of materials including, but not limited to, ceramics, glass, diamond, coal, and combinations thereof. Ceramics useful in exemplary embodiments of the present disclosure may include, but are not limited to, metal oxide, metal boride, metal carbide, lithium-based ceramics, and combinations thereof. Specific abrasive particles 4 that may be useful in exemplary embodiments of the present disclosure can include, but are not limited to, boron carbide, silicon carbide, zirconium oxide, and aluminum oxide. In one embodiment of the present disclosure, ceramic particles may be created using vapor phase reaction sintering to produce particles having high density, strength and hardness characteristics useful for producing armor materials of the present disclosure.

Hardness is related to compression resistance. In general, the abrasive particles and abrasive powders of the present disclosure may have a Mohs' Hardness of 5 or greater, or 6 or greater. Preferably, the abrasive particles and abrasive powders can have a Mohs' hardness of 7 or greater, more preferably, the abrasive particles and abrasive powders can have a Mohs' hardness of 8 or greater, and most preferably, the abrasive particles and abrasive powders can have a Mohs' hardness of 9 or greater. Examples of materials having a Mohs' Hardness of 6 or greater include, but are not limited to:

| Abrasive Material | Mohs' Hardness |
|---|---|
| Glass | 6 |
| Garnet | 7 |
| Glass (lead free) | 7 |
| Quartz | 7 |
| Zirconium silicate | 7 |
| Topaz | 8 |
| Zirconium oxide | 8 |
| Chrysoberyl | 8.5 |
| (BeAl₂O₄) | |
| Aluminum Oxide | 9 |
| Silicon Carbide | 9 |
| Tungsten Carbide | 9 |
| Boron Carbide | 9-10 |

Metallic coatings 10 may be applied to the discrete abrasive particle 4 using any suitable coating technique known for applying a coating thickness of between a monolayer and about 1250 microns thick to a plurality of discrete abrasive particles. Metal coating techniques that may be used with the exemplary embodiments of the present disclosure can include, but are not limited to, plasma spraying, spray coating and electroless plating. In an embodiment of the present disclosure, an electroless plating process may be used to coat the second metal onto the discrete abrasive particles. It should be noted, that an agglomeration of abrasive particles composed of two or more abrasive particles may be considered discrete so long as the abrasive particles are not directly bonded to one another.

In exemplary embodiments of the present disclosure, the coated discrete abrasive particles are generally suspended in a continuous first metal phase. The first metal of the present disclosure may be a non-ferrous metal or non-ferrous metal alloy. Non-ferrous metals useful as the first metal of the present disclosure include, but are not limited to, titanium, nickel, aluminum, magnesium, brass, copper, beryllium, platinum, silver, bronze, brass, and combinations thereof.

The metallic coating applied to the discrete abrasive particles includes a second metal. In embodiments of the present disclosure, the second metal may be a non-ferrous metal or non-ferrous metal alloy. In another embodiment, the second, non-ferrous metal may be nickel or titanium.

In some embodiments, a second coating comprising a third metal may be applied to the discrete abrasive particles already coated with a second metal. The third metal may be the same as the second metal, or it could be another metal, for instance aluminum.

The coating may consist essentially of residue free second metal. Although there may be some mixing of the first metal and the second metal at the interface, the second metal would still be residue free so long as the second metal does not contain residue, whether solid fragments or dissolved constituents, of the discrete abrasive particles.

In an embodiment of the present disclosure, the first metal and the second metal may be different metals. However, the first metal and the second metal may also be the same metal. In some embodiments of the present disclosure, the coating on the discrete abrasive particles does not contain the first metal.

In composites of exemplary embodiments of the present disclosure, the continuous phase comprising first metal may comprise between 5% and 80% of the total weight of the armor composite. In another embodiment, the continuous first metal layer may account for between 5% and 50% of the total weight of the armor composite. In another embodiment, the continuous first metal layer may account for between 5% and 20% of the total weight of the armor composite.

FIGS. 1A & B depict a plurality of coated discrete abrasive particles 6 composed of discrete abrasive particles 4, that are continuously coated by a coating material 10 and suspended in a continuous phase comprising a first metal 8. FIG. 1 shows both a molten metal 14 approach and a metal particle 16 approach. Interactions between the coated discrete abrasive particles 6 and first metal containing particles, flakes, or grains 16 are also shown in FIG. 1. Also shown are interactions between a coated discrete particle 6 and a molten first metal 14 comprising material. In general, the molten metal 14 completely surrounding the coated discrete abrasive particle 6 depicted therein, in composites of exemplary embodiments of the present disclosure the molten metal 14 will generally completely surround the coated discrete abrasive particle 6 (not shown).

FIG. 1B depicts a detailed view of the interface between a metal coating 10 and a discrete abrasive particle 4. In some embodiments the metal coating material 10 may include, but is not limited to, metals such as nickel or metal compounds such as titanium nitride.

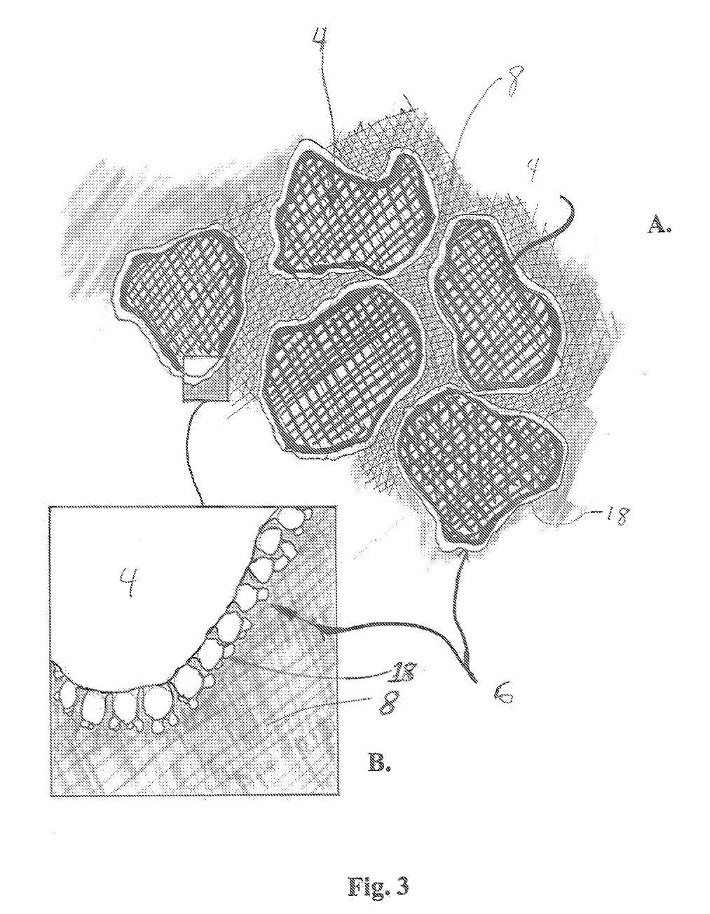

As shown in FIGS. 3A and 3B, the coated discrete abrasive particles 6 that are also useful in exemplary embodiments of the present disclosure include discrete abrasive particles 4 that are coated with an abrasive powder 18. The abrasive powder 18 can be sintered to the underlying discrete abrasive particle 4.

The function of the powder coating 18 is similar to that of the continuous metal coating 10 embodiments described above. The abrasive powder coating 18 provides improved bonding between the continuous phase comprising the first metal 8 and the abrasive powder 18 coated discrete abrasive particles 6. The surface roughness provided by the powder coating 18 creates unexpectedly strong mechanical bonds between the continuous phase comprising a first metal 8 and the powder coated 18 discrete abrasive particles 4. The continuous phase-powder bonds are so strong that the failure mechanism of armor composites using the powder coated discrete abrasive particles may be the sintered bond between the abrasive powder 18 and the discrete abrasive particle 4, not the bond between the continuous phase comprising a first metal 8 and the abrasive powder 18 coated discrete abrasive particles 6.

The abrasive powder 18 may be a material including, but not limited to, ceramics, glass, diamond, coal, and combinations thereof. The abrasive powder may be a ceramic, including but not limited to, a metal oxide, metal boride, metal carbide, lithium-based ceramics, and combinations thereof. The abrasive powder may be a ceramic including, but not limited to, boron carbide, silicon carbide, zirconium oxide, and aluminum oxide. The abrasive powder and the discrete abrasive particle may comprise the same ceramic, or they may be different.

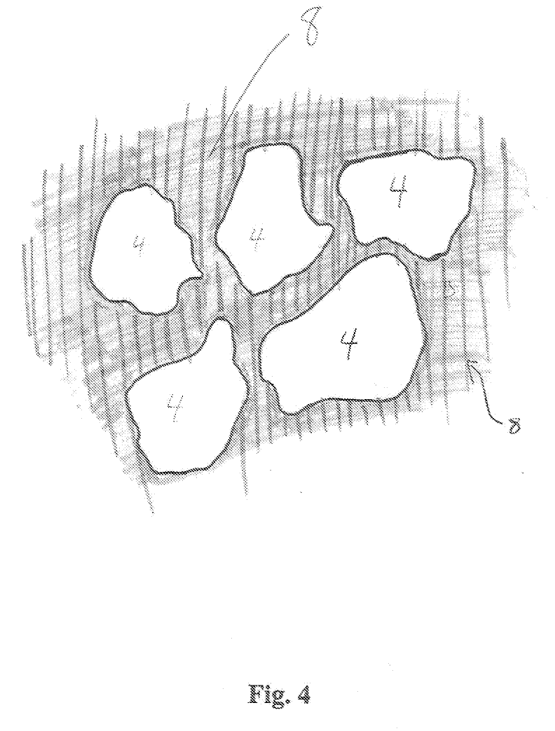

As shown in FIG. 4, exemplary embodiments of the present disclosure include a plurality of discrete abrasive particles 4 that are suspended in a continuous phase comprising a first metal 8. In uncoated embodiments, such as that shown in FIG. 4, the discrete abrasive particles 4 are generally larger is size than the discrete abrasive particles used in the embodiments where coated discrete abrasive particles are used 6.

The exemplary embodiments of the present disclosure can also include an armor system that includes an armor composite attached to a substrate material. As used herein, the term “attached” refers to both containment and physical attachment, such as bolting, riveting or adhering. For example, containment includes, but is not limited to, embodiments where an armor plate is placed inside a pocket in a substrate, such as a garment or temporary shelter. Some embodiments where armor composites and systems disclosed herein may be useful include, but are not limited to, military helmets, chest and back plates, personnel ballistic shields, body armor, armor panels, armored vehicles, and hardened buildings or parts of buildings. Several examples are shown in FIG. 2.

Another aspect of exemplary embodiments of the present disclosure is a method of producing an armor composite that includes providing a first metal containing material. The first metal containing material may be heated to a maximum temperature that is less than the sintering temperature of the abrasive particles. The first metal containing material and the discrete abrasive particles are combined and then cooled. Because the abrasive particles are exposed only to temperatures below the sintering temperatures of the abrasive particles, the discrete abrasive particles in the armor composite created by the process will remain discrete abrasive particles. The discrete abrasive particles may have an average particle size up to about 2 centimeters.

The plurality of discrete abrasive particles may include a plurality of coated discrete abrasive particles. The coated discrete abrasive particles may be coated with (i) a metallic coating comprising a second metal or (ii) an abrasive powder.

The first metal may be heated to a temperature where the first metal begins to soften. As used herein, “soften” is used to describe the point at which adjacent metal particles begin to join together or where the metal begins to slowly ooze or seep. Thus, the temperature at which the first metal begins to soften will be less than the melting point of the first metal.

The first metal may be heated to a maximum temperature at the melting point of the first metal or temperatures below the melting point of the first metal. In another embodiment of the present disclosure, the first metal may be heated to a maximum temperature below the sintering temperature of the abrasive particles.

The first metal may be maintained at the heating temperature for less than 4 hours. In another embodiment, the first metal may be maintained at the heating temperature for less than 1 hour, in another embodiment less than 10 minutes, and in another embodiment less than 2 minutes.

The inventive process may utilize particles, flakes, or pellets of the first metal containing material. The particles or flakes of the first metal containing material may be combined with the discrete abrasive particles and/or coated discrete abrasive particles prior to heating the first metal containing material. The mixture of the first metal and the coated discrete abrasive particles and/or discrete abrasive particles may be placed into a mold and then heated. The mold may be cooled following the heating step.

Another embodiment to the inventive method uses particles, flakes, pellets, or blocks of the first metal containing material. In this method, the discrete abrasive particles and/or coated discrete abrasive particles are placed in a pressure mold. The first metal containing material is then melted and poured into the pressure mold. While the liquid first metal containing material and discrete abrasive particles and/or coated discrete abrasive particles would normally separate, the pressure mold forces the particles down into the molten first metal containing material. The final step is to allow the composite inside the mold to cool.

Two exemplary molding methods that may be useful in the above embodiments are self-pressed molding and hydraulic press molding. A self-pressed mold may generally be a three-piece mold made of iron, steel, or alloys thereof. Two parts form a base mold that separates to release the molded part. The third piece may be a large block of steel or iron, typically weighing between 20 and 150 kilograms, that fits over the two-part base mold.

For self-press molding embodiments that utilize metal first metal containing particles, the discrete abrasive particles and/or coated discrete abrasive particles and the metal containing particles are mixed and placed in the base mold. The large, fitted block may be placed over the base mold and the mold heated.

The self-press molding embodiments that utilize liquid metal are generally more involved. Generally, one piece of the base mold may be placed on the ground, or other suitable surface, cavity side up. A wire mesh made out of a first metal containing material may be placed on top of the base mold. The coated discrete abrasive particles and/or discrete abrasive particles may then be placed on the wire mesh. Another layer of wire mesh may be placed on top of the discrete abrasive particles and/or coated discrete abrasive particles. The molten metal may be poured over the layers of mesh and discrete abrasive particles and/or coated discrete abrasive particles and the mold may be closed using the top half of the base mold. The large, fitted block may be placed over the base mold. In some embodiments, spacers may be placed within the base mold cavity in order to alter the metal-to-ceramic ratio or the placement of the discrete abrasive particles and/or coated discrete abrasive particles within the composite. The entire mold may then be placed inside a standard ceramic kiln. Because, the kiln is not used to sinter or decompose the discrete abrasive particles, the kiln need only be capable of heating to about 1,315 degrees Celsius (about 2,400 degrees Fahrenheit).

Another exemplary method of forming the composites relies on hydraulic press molding. As will be recognized by one of ordinary skill in the act, hydraulic press molding methods are similar to self-press molding except for a hole in the kiln lid and an extension arm fitted to the hydraulic press. Pressure is applied and the kiln is heated. In some embodiments, water cooling tubes may be incorporated into the mold design to quickly cool the composite material.

Another exemplary method of making the composites is centrifugal casting. Much like the molding techniques described above, the discrete abrasive particles and/or coated discrete abrasive particles may be mixed with particles, flakes, or pellets of the first metal containing material and placed in the centrifugal casting mold and then processed by heating and cooling the mold contents. The present disclosure also contemplates the molten first metal comprising material can being added once the discrete abrasive particles and/or coated discrete abrasive particles are already deposited in the centrifugal casting mold. In order to make high strength armor composites, it is important that a sufficient amount of discrete abrasive particles and/or coated discrete abrasive particles are present in the mold that no voids are created toward the center of the armor composite.

The present composites may be made much more economically and rapidly than conventional armor plates that incorporate a preformed ceramic matrix. Using the present methods, no preformed sintered ceramic matrix is used. Sintering of abrasive particles to form a ceramic matrix requires maintaining extremely high temperatures, about 1,540 degrees Celsius (2,800 degrees Fahrenheit), for an extended period of time, typically several hours or more. In exemplary embodiments of the present method, the discrete abrasive particles may be coated with a bonding enhancer, i.e. a metal coating or an abrasive powder coating. Since the discrete abrasive particles are coated with a bonding enhancer, the bonds between the discrete abrasive particles and the metallic continuous phase are stronger than without the coating and form a highly stable matrix that enables the unexpected armor functionality of the claimed armor. Since the coating-to-metal bonds generally form much more rapidly and at a lower temperature than sintered ceramic-to-ceramic bonds, the present disclosure provides a significant cost reduction and productivity improvement over conventional armor plates that incorporate a preformed ceramic matrix. Although formation of the armor composite does not require sintering of an underlying preformed matrix, the discrete abrasive particles may be individually sintered prior to their inclusion in the armor composite.

The present disclosure also provides improved ballistic performance over conventional armor plates that incorporate a preformed ceramic matrix. Ceramic-metal composites used as armor are generally believed to break the bullet into pieces by forcing energy back into the bullet. Ceramics are useful in this capacity because they are extremely resistant to compression. Thus, if the ceramic particles are relatively immobile when impacted by a bullet they will force an amount of energy back into the bullet roughly proportional to the surface area of the particle that contacts the bullet. Prior art structures rely on small ceramic particles to create a dense packing of ceramic particles that immobilizes individual ceramic particles. Such a sintered ceramic is referred to as a plate. The prior art armor relies on ceramic-to-ceramic bonds to immobilize the ceramic particles, with the metal providing additional support.

While the prior art approach may be effective for initial impacts, the effectiveness is severely diminished if the particles are allowed to move more freely because the underlying ceramic plate is fractured. Such a fracture, may be caused by any sudden impact, for instance if a plate is dropped, an armored truck containing the plate is involved in an accident, or if the armor has been struck previously by a projectile.

Unlike previously available materials, armor composites of exemplary embodiments of the present disclosure contain few, if any, bonds between adjacent abrasive particles. The exemplary embodiments of the present disclosure can provide coated discrete abrasive particles or large discrete abrasive particles suspended in the continuous phase comprising a first metal phase to break apart the incoming projectile.

While not wishing to be bound to the proposed mechanism, it is believed that the proposed mechanism helps explain the superior ballistic performance of the present armor composites. Because the coated discrete abrasive particles exhibit improved bonding to the continuous first metal containing phase, the bonds are strong and deformable. This allows the exemplary embodiments of the armor system to withstand impacts, whether blunt force or impinging projectiles, that conventional sintered-ceramic-based plates could not. In addition, each coated discrete abrasive particle is immobilized because the coated discrete abrasive particles are strongly bonded in a tight and uniform configuration within the armor composites. Since the discrete abrasive particles are resistant to compression and the bonds are not brittle, this immobilization allows the coated discrete abrasive particles to force more energy into the impinging projectile than the prior art. Accordingly, the coated discrete abrasive particles may be suspended uniformly within the continuous first metal phase.

Based on this proposed mechanism, the armor composites of exemplary embodiments of the present disclosure may provide excellent ballistic performance over a much broader range of abrasive particle, particle sizes than the preformed ceramic armors of the prior art. Thus, although the discrete abrasive particles described herein typically have an average diameter of less than about 2 centimeters, the discrete abrasive particles of the present disclosure may be even larger in some applications, such as where thicker armor plates are useful or necessary. Thus, the discrete abrasive particles may have an average diameter of 3, 4, 5 or even 10 centimeters in some applications.

The following performance data may help one of ordinary skill in the art better appreciate the exemplary embodiments of the present disclosure, but should not be construed as limiting the scope or content of the disclosure in any way. Armor composites of the exemplary embodiments of the present disclosure may have surface tensile strength of 2,380 atm (35,000 psi), or even up to 13,600 atm (200,000 psi). This is significantly higher than the tensile strength of conventional sintered-ceramic-based plates. Thus, the materials of the exemplary embodiments of the present disclosure may be ideal for applications, such as in armored vehicles, where the material may be exposed multiple projectiles or to blunt force impacts prior to being impacted by a bullet or other projectile.

In addition, the individual abrasive particles are not generally in direct physical contact so the bullet only disrupts ceramic material directly in the bullet's path. As a result, the continuous first metal comprising phase may melt leaving a cone shaped bullet hole with the point of entry being the smallest part. In some embodiments, an armored plate is fully capable of defeating more than 750 bullets per square meter (70 bullets/ft²) for bullets having a diameter of 7.62 mm. As will be recognized by one of ordinary skill in the art, use of a larger the projectile will result in proportionately fewer hits per unit area. The materials of the exemplary embodiments of the present disclosure may be changed to create lighter, stronger, higher tensile strength materials with improved protection against armor piercing munitions. One or ordinary skill in the art will recognize that such modifications may be made without deviating from the scope and spirit of the present invention.

The armor system may be used in nearly any application where armor is used. The substrate material may be any of the following, including, but not limited, a catch layer, a drag layer, a vehicle component, an article of clothing, a fabric, a piece of combat equipment, a portion of a permanent shelter or a portion of a temporary shelter. Thus, the substrate may be a metal comprising material, a fiber comprising material, a polymer comprising material, a ceramic comprising material, an abrasive comprising layer, or a combination thereof.

An exemplary catch layer that may be used in the exemplary embodiments of the present disclosure armor system is a reinforced metal plate. The reinforcing material may be woven carbon fiber, fiberglass, or both. The exemplary reinforced metal plate can be produced by stacking metal comprising foil between reinforcing layers and placing the metal-reinforcement sandwich in a hot press. A powder of the metal comprising the foil may also be included between the reinforcing layers. The foil and powder may comprise metals including, but not limited to, aluminum, nickel, bronze, non-ferrous alloys, and combinations thereof. The reinforcing material and metal sandwich may be heated until the metal melts. The reinforcing material and foil sandwich may be pressed under a pressure of about 27 atm (about 400 psi) or more and then cooled, for instance using water cooling, to form a reinforced metal plate. In some embodiments, the reinforcing material and metal sandwich may made using aluminum flake or powder layers between the reinforcing material layers, without any foil.

The disclosed reinforced metal plate forming method ensures that the metal placed between the reinforcing material cannot escape from the mold once the pressure is applied. Because the metal cannot escape, the pressure forces the molten metal into the fine spaces between the reinforcing fibers where it would not otherwise reach. The reinforced metal plate may be used as a backing, or catch layer, supporting an armor composite as part of an armor system of the present disclosure. The reinforced metal plate may be bonded to the armor composite, built into the armor composite or fabricated in tiles and placed in a layered composite in order to form a large armor panel for use in the exemplary embodiments of the armor system.

One method of using the reinforced metal plate is making a tile square, for instance a 4″ tile or a 6″ tile. The reinforced metal plate tiles may be layered to form a large reinforced panel. The tiles may be layered so that after three layers the reinforced panel does not contain any ballistically weak seams. The reinforced metal plate tiles may be used alone, in combination with metal-ceramic composite plates, or made into a reinforced panel, such as would be useful as body armor. The reinforced tile squares are easy to manufacture and much cheaper than making a single, large reinforced panel. An individual reinforced metal plate tile has been tested 9 mm full metal jacket at 1600 feet per second. A four-layer reinforced panel performed at level 4 standards (i.e. resistant to 0.30-06 armor piercing munitions).

The exemplary embodiments of the present disclosure can substantially aid in homeland defense by countering terrorism. Improved armor products having improved ballistic performance for both vehicles and individuals will lessen, reduce and in some cases eliminate injuries due to terrorist attacks, including but not limited to projectiles, such as bullets from guns and shrapnel from explosions. In addition, the inventive armor systems can help counter terrorism because they may be produced more rapidly, supplied in greater quantities, and sold at lower costs, in order to rapidly address the existing civilian and military needs for armor systems.

The foregoing is provided for purposes of illustrating, explaining, and describing embodiments of this invention. Modifications and adaptations to these embodiments will be apparent to those skilled in the art and may be made without departing from the scope or spirit of this invention.

We claim:

1. An armor composite comprising:
a continuous phase comprising a first metal; and
a plurality of discrete abrasive particles with each having a coating thereon, said plurality of coated discrete abrasive particles being suspended in the continuous phase, wherein a first bond strength between the plurality of discrete abrasive particles with the coating and the continuous phase is higher as compared to a second bond strength between the plurality of discrete abrasive particles without the coating and the continuous phase.

2. The armor composite of claim 1, wherein said coating comprises a second metal.

3. The armor composite of claim 2, wherein the coating consists essentially of a residue free second metal.

4. The armor composite of claim 2, wherein the average size of each of the plurality of discrete abrasive particles is greater than 50 microns.

5. The armor composite of claim 2, wherein the continuous phase comprising the first metal comprises between 5% and 50% of the weight of the armor composite.

6. The armor composite of claim 2, wherein the coating contains 1% or less of the first metal.

7. The armor composite of claim 2, wherein the plurality of discrete abrasive particles comprise a material selected from the group consisting of a ceramic, glass, diamond, coal and any combinations thereof.

8. The armor composite of claim 2, wherein the plurality of discrete abrasive particles comprise a ceramic selected from the group consisting of a metal oxide, a metal boride, a metal carbide, a lithium-based ceramic, and any combinations thereof.

9. The armor composite of claim 2, wherein the plurality of discrete abrasive particles comprise a ceramic selected from the group consisting of boron carbide, silicon carbide, zirconium oxide, and aluminum oxide.

10. The armor composite of claim 2, wherein the first metal comprises a non-ferrous metal or a non-ferrous alloy selected from the group consisting of titanium, nickel, aluminum, magnesium, brass, copper, beryllium, platinum, silver, bronze, brass, and any combinations thereof.

11. The armor composite of claim 2, wherein the second metal is a non-ferrous metal or an alloy of a non-ferrous metal selected from the group consisting of nickel, titanium and any combinations thereof.

12. The armor composite of claim 1, wherein said coating comprises an abrasive powder that is bonded to said discrete abrasive particles, and wherein a particle size of said discrete abrasive particle is at least 4 times larger than a particle size of said abrasive powder.

13. The armor composite of claim 12, wherein the plurality of discrete abrasive particles and the abrasive powder are materials independently selected from the group consisting of a ceramic, glass, diamond, coal and any combinations thereof.

14. The armor composite of claim 13, wherein the plurality of discrete abrasive particles and the abrasive powder are the same material.

15. An armor composite comprising:
a continuous phase comprising a first metal; and
a plurality of discrete abrasive particles, wherein said plurality of discrete abrasive particles are suspended in the continuous phase first metal and an average size of each the plurality of discrete abrasive particles is greater than 250 microns.

16. The armor composite of claim 15, wherein the continuous phase comprising the first metal is essentially residue free first metal.

17. The armor composite of claim 16, wherein at least a portion of the plurality of discrete abrasive particles has a coating comprising a second metal.

18. An armor system, comprising:
a substrate; and
a continuous phase comprising a first metal; and
a plurality of discrete abrasive particles with each having a coating thereon, said plurality of discrete abrasive particles being suspended in the continuous phase, wherein a first bond strength between the plurality of discrete abrasive particles with the coating and the continuous phase is higher as compared to a second bond strength between the plurality of discrete abrasive particles without the coating and the continuous phase; and wherein the armor composite is attached to the substrate.

19. The armor system of claim 18, wherein the substrate comprises a material selected from the group consisting of a metal, a fiber, a polymer, a ceramic, an abrasive layer, and any combinations thereof.

20. A method of making armor, the method comprising:
providing a first metal;
providing a plurality of discrete abrasive particles;
heating the first metal to a maximum temperature less than a sintering temperature of the plurality of discrete abrasive particles;
mixing the plurality of discrete abrasive particles with the first metal to form a mixture;
cooling the mixture to form an armor composite; and
attaching the armor composite to a substrate.

21. The method of claim 20, further comprising coating at least a portion of said plurality of discrete abrasive particles with a second metal.

22. The method of claim 21, wherein the second metal is applied to the at least a portion of the plurality of discrete abrasive particles using electroless plating.

23. The method of claim 20, further comprising coating at least a portion of said plurality of discrete abrasive particles with an abrasive powder that is bonded to said abrasive particle, wherein a particle size of said abrasive particle is at least 4 times larger than a particle size of said abrasive powder.

24. The method of claim 20, wherein the maximum temperature is less than a melting temperature of the first metal.

25. The method of claim 20, wherein the substrate comprises a material selected from the group consisting of a metal, a fiber, a polymer, a ceramic, an abrasive layer, and any combinations thereof.
